(19) United States
(12) Patent Application Publication
(10) Pub. No.: US 2017/0253787 A1
(43) Pub. Date: Sep. 7, 2017

(54) COMPLEX EMULSIFIER COMPOSITIONS AND METHODS OF USE

(71) Applicant: M-I L.L.C., Houston, TX (US)

(72) Inventors: Yiyan Chen, Sugar Land, TX (US); Steven Young, Houston, TX (US)

(21) Appl. No.: 15/057,327

(22) Filed: Mar. 1, 2016

(51) Int. Cl. C09K 8/50; E21B 21/00

(52) U.S. Cl. CPC C09K 8/50; E21B 21/003

(57) ABSTRACT

Wellbore fluid compositions herein may include an oleaginous base fluid having an aqueous internal phase forming a micelle, a solid phase material, a hydrophobic surface modifier that interacts with the solid phase material, and a bifunctional surface modifier with a first functional group capable of interacting with the solid phase material, and a second functional group of the bifunctional surface modifier that interacts with the micelle. Methods herein may include emplacing a wellbore fluid into a wellbore, the wellbore fluid containing an oleaginous base fluid, a solid phase material, and a hydrophobic surface modifier that interacts with the solid phase material. The fluid may further include a bifunctional surface modifier with a first functional group capable of interacting with the solid phase material, and a second functional group capable of interacting with a micelle of the aqueous fluid.

### BACKGROUND

During the drilling of a wellbore, various fluids are typically used in the well for a variety of functions. The fluids may be circulated through a drill pipe and drill bit into the wellbore, and then may subsequently flow upward through wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the subterranean formation by providing sufficient hydrostatic pressure to prevent the ingress of formation fluids into the wellbore, to cool and lubricate the drill string and bit, and/or to maximize penetration rate.

### DETAILED DESCRIPTION

Embodiments disclosed herein are directed to complex emulsifier compositions that are used to stabilize emulsified wellbore fluids. Complex emulsifiers in accordance with the present disclosure may contain a solid phase material, a hydrophobic surface modifier, and a bifunctional surface modifier that forms complexes, such as macromolecular complexes, for example, that assemble at the phase boundary of an emulsified wellbore fluid, and may create emulsions with improved rheologies, stability, fluid loss, sag control, or the like. Complex emulsifier compositions may be added to a wellbore fluid to improve emulsion stability, and to stabilize invert emulsions, and to stabilize the wellbore in some embodiments.

Wellbore fluid emulsions prepared from small molecule surfactants may create relatively weak micelles that are susceptible to rupture and coalescence of the internal phase during storage depending on the chemical makeup of the wellbore fluid, particularly at high-pressure, high-temperature (HPHT) conditions. Many emulsion stability issues may be attributed to a number of causes including insufficient emulsifier hydrolytic stability, and weak emulsion droplet membranes that degrade over time.

Complex emulsifiers in accordance with the present disclosure may form pickering emulsions, for example, in which solid particles adsorb onto the interface between the fluid phases of the emulsified fluids, and organize into complexes in some embodiments. In other embodiments, complex emulsifiers may also increase yield point and/or yield stress of an emulsified wellbore fluid, and may also maintain stability at HPHT conditions in which standard invert emulsion fluids may experience micelle droplet degradation, such as by the coalescence of micelles into larger droplets, thus leading to fluid degradation.

In one or more embodiments, complex emulsifiers may include a solid phase material that has been modified using one or more hydrophobic surface modifiers to increase the interaction between the solid particle surface and oleaginous fluids in solution. Further, hydrophobic surface modifiers may include alkyl chains that are capable of increasing the stability of the emulsion. To this end, the solid phase particles may undergo various forms of interaction, such as linking together through physical entanglement of the alkyl chains with those of neighboring solid phase material particles, associating with each other without the hydrophobic modifying tails, or the like.

In some embodiments, complex emulsifiers may include solid phase materials that have been modified with a bifunctional surface modifier that introduces hydrophilic functional groups, for example, onto the surface of the solid phase particle, and increases the interaction of the solid phase particle with micelles of the aqueous fluids. For example, a bifunctional surface modifier in accordance with the present disclosure may include a hydrophilic functional group that is capable of interacting with a micelle of an aqueous phase of an emulsified fluid, which may enhance anchoring and coordination of the solid phase material around the aqueous phase.

In some embodiments, complex emulsifiers in accordance with the present disclosure may also be used to prepare stable emulsions from oleaginous base fluids such as internal olefins that are becoming more widespread as a “green” alternative to diesel oils. Common emulsifiers often underperform when used with internal olefin base fluids dues to the changes in polarity when compared with standard base oils. Emulsion stability may be further hindered by extreme temperature and pressure conditions that can degrade surfactants and other wellbore fluid components.

Solid Phase Materials

Complex emulsifier compositions in accordance with the present disclosure may include a solid phase material that may form Pickering-type emulsions when combined with an emulsified wellbore fluid. Solid phase materials may also be functionalized with various reagents to tune surface properties such as increasing the hydrophobicity or hydrophilicity of the solid phase material. Reagents such as hydrophobic surface modifiers and bifunctional surface modifiers may be combined with the solid phase material during grinding or in solution phase, and may be combined prior to use or in situ in a wellbore.

In some embodiments, solid phase materials may also be modified by covalent or noncovalent interactions to include chemical functional groups that enhance emulsion stability by strengthening the interaction of the solid phase material with the internal and/or external phases of an emulsion. For example, surface modification of the solid phase material may include the exchange of sodium cations in the inorganic clay with hydrophobic surface modifiers such as tetraalkyl ammonium salts.

In one or more embodiments, the solid phase material may be a particulate clay such as montmorillonite, nontronite, beidellite, bentonite, volkonskoite, laponite, hectorite, saponite, sauconite, magadite, kenyaite, stevensite, vermiculite, halloysite, hydrotalcite, attapulgite, sepiolite, and the like, and combinations thereof. In one or more embodiments, the solid phase material may include fibers, silica, silicon materials, alumina particles, zirconia particles, and titania particles. In other embodiments, the solid phase material may include organic particles such as latexes and other polymer particles.

In one or more embodiments, the solid phase material may be a particulate having an average particle size (or average overall length for fibers or oblate particles), as determined by laser diffraction, sedimentation, or microscopy, for example, that ranges from a lower limit selected from 500 nm, 1 μm, 5 μm, 10 μm, 25 μm, 50 μm, or 100 μm, to an upper limit selected from 500 μm, 1 mm, 1.5 mm, or 2 mm, where the average particle size may range from any lower limit to any upper limit. The particle size of the solid phase material may be on the order of 200-400 mesh in some embodiments, or 500 mesh or finer in other embodiments.

Solid phase materials in accordance with the present disclosure may be added to a wellbore fluid at a percent by weight (wt %) that ranges from 0.1 to 5.0 wt % in some embodiments, and from 0.5 to 3.0 weight percent in other embodiments.

Hydrophobic Surface Modifier

In one or more embodiments, the solid phase material may be combined with a hydrophobic surface modifier that imparts hydrophobic functionality to the surface of the solid phase material. Hydrophobic surface modifiers in accordance with the present disclosure may have the general formula R¹-R², where R¹ is a functional group that interacts through covalent or non-covalent interactions with the solid phase material, and R² is a C8 to C30 alkyl or alkene that may be linear or branched.

In one or more embodiments, hydrophobic surface modifiers in accordance with the present disclosure that are used in combination with a clay solid phase material, or a negatively-charged solid phase material may include a R¹ that is cationic such as azide, trialkylammonium ion, trialkylphosphonium ion, dialkyl sulfonium ion, and the like. In some embodiments, the hydrophobic surface modifier may comprise an amine, such as comprising an ammonium functional group, a protonated amine, or a quaternary amine, for example, in which one or more of the alkyl substituents is a C8-C18 alkyl.

In one or more embodiments, hydrophobic surface modifiers may include 1,2dimethyl-3-hexadecylimidazolium, 1-decyl-2,3-dimethylimidazolium, 1-butyl-2,3-dimethylimidazolium, 1,2-dimethyl-3-propylimidazolium, 1,2-dimethyl-3-hexadecylimidazolium, dimethyldioctadecyl ammonium bromide, Triphenyldodecyl phosphonium bromide, tributyltetradecylphosphonium bromide, tributylhexadecyl phosphonium bromide, tributyloctadecyl phosphonium bromide, tetraphenyl phosphonium bromide, tetraoctylphosphonium bromide, tetraoctylammonium bromide, triphenyl pyridinium chloride, Bis(2-hydroxyethyl)methyl tallow ammonium, bis(2-hydroxyethyl)methyl octadecyl ammonium, trimethyl tallow ammonium, trimethyl hydrogenated-tallow ammonium, dimethyl hydrogenated tallow ammonium, methyl bis(hydrogenated-tallow)ammonium, dimethyl bis(hydrogentated-tallow)ammonium, dimethyl benzyl hydrogenated-tallow ammonium, 12-aminolautic acid ammonium, bis(polyoxyethylene)methyl octadecyl ammonium, dimethyl bis(ethylene oxide-co[propylene oxide) ammonium, dimethyl bis(ethylene oxide-co-propylene oxide) ammonium, and the like.

In one or more embodiments, the solid phase material of the complex emulsifier composition may contain a siliceous surface and R¹ may be a silylated alkyl such as trialkoxysilyl alkyls such as octyltrimethoxysilane, decyltrimethoxysilane, Dodecyltriethoxy silane, octadecyltrimethoxy silane, and the like. Hydrophobic surface modifiers may also include functional R¹ end group that interacts with functional groups on the surface of the solid phase particles such as epoxy or isocyanate.

In one or more embodiments, the hydrophobic surface modifier is added to the solid phase material at a weight ratio of hydrophobic surface modifier to solid phase material (w/w %) that may range from 1 w/w % to 200 w/w % in some embodiments, and from 5 w/w % to 100 w/w % in other embodiments.

Bifunctional Surface Modifier

In one or more embodiments, complex emulsifiers in accordance with the present disclosure may include a bifunctional surface modifier that associates with the solid phase material and interacts with the micellular region of base fluid, such as by providing hydrophilic functionality that increases the compatibility of the solid phase material with aqueous fluids and enhances the stability emulsified wellbore fluids.

Bifunctional surface modifiers in accordance with the present disclosure possess a molecular structure having a first functional group that interacts with the solid phase material, including all of those described above with respect to the hydrophobic surface modifier, which is linked by way of a hydrocarbon spacer to a second functional group that may be hydrophilic and interacts with micelles of aqueous fluids. For example, depending on the nature of the surface chemistry of the solid phase material, the first functional group may include functional groups that interact with the solid phase material through non-covalent interactions such as ammonium or other cationic groups, and or functional groups that form covalent bonds to the surface such as silanes, epoxies, isocyanates, etc.

In one or more embodiments, bifunctional surface modifiers may be of the general formula R¹R³R⁴, wherein R¹ is a functional group that interacts through covalent or non-covalent interactions with the solid phase material as described above with respect to the hydrophobic surface modifier, R³ is a hydrocarbon spacer, and R⁴ is a hydrophilic functional group.

Bifunctional surface modifiers in accordance with the present disclosure include a hydrophilic functional group that is capable of interacting with a micelle within an aqueous phase that includes anionic, nonionic, and zwitterionic species. Anionic species in accordance with the present disclosure include carboxylates, sulfonates, sulfates, phosphates, phosphonates, and the like (and it is also intended that derivatives such as the corresponding acid groups may be used as well). Bifunctional surface modifiers may also include a hydrophilic functional group that is nonionic such as a polyalkylene glycol, which may include polyethylene glycol or polypropylene glycol, polyglycosides, amides, amine, polyols (like sorbitol, glycerol derivatives) and the like. Hydrophilic functional groups may also include zwitterionic species such as amino acids, sulfobetaines, phosphobetaines, and carboxybetaines.

In one or more embodiments, the two functional groups of the bifunctional surface modifier may be covalently linked by a hydrocarbon spacer R³. The hydrocarbon spacer may be a C8 to C24 alkyl or alkenyl, in some embodiments, and may contain one or more heteroatoms such as oxygen, nitrogen, or sulfur. In some embodiments, the hydrocarbon spacer may be selected such that the overall length of the bifunctional surface modifier is greater than that of the hydrophobic surface modifier. Increasing the overall length of the bifunctional surface modifier with respect to the hydrophobic surface modifier may aid in extending the second functional group from the surface of the solid phase material and increase the accessibility of the second functional group to the surrounding fluid environment.

In one or more embodiments, the bifunctional surface modifier is added to the solid phase material at a weight ratio of bifunctional surface modifier to solid phase material (w/w %) that may range from 0.1 w/w % to 75 w/w % in some embodiments, and from 0.5 w/w % to 50 w/w % in other embodiments.

In one or more embodiments, the ratio of the hydrophobic surface modifier and bifunctional surface modifier may be used to tune the stability of the resulting complex emulsifier. The molar ratio (mol/mol) of hydrophobic surface modifier to bifunctional surface modifier may be in the range of 1:1 to 100:1 mol/mol in some embodiments, and from 5:1 to 75:1 mol/mol in other embodiments.

Base Fluids

Wellbore fluids in accordance with the present disclosure may be formulated as a water-in-oil or oil-in-water emulsion and, in some cases, a high internal phase ratio (HIPR) emulsion in which the volume fraction of the internal phase is a high as 90 to 95 percent. In some embodiments, wellbore fluids may contain an external oleaginous solvent component and an internal aqueous component having a ratio of the internal aqueous component to the external oleaginous component with the range of 30:70 to 95:5 in some embodiments, from 50:50 to 95:5 in some embodiments, and from 70:30 to 95:5 in yet other embodiments.

Suitable oleaginous fluids that may be used to formulate emulsions may include a natural or synthetic oil and in some embodiments, in some embodiments the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof.

Aqueous fluids useful for preparing wellbore fluid formulations in accordance with the present disclosure may include at least one of fresh water, sea water, brine, mixtures of water and water-soluble organic compounds, and mixtures thereof. In various embodiments, the aqueous fluid may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts. Additionally, brines that may be used in the wellbore fluids disclosed herein may be natural or synthetic, with synthetic brines tending to be much simpler in constitution. In one embodiment, the density of the wellbore fluid may be controlled by increasing the salt concentration in the brine (up to saturation, for example). In a particular embodiment, a brine may include halide or carboxylate salts of mono- or divalent cations of metals, such as cesium, potassium, calcium, zinc, and/or sodium.

In one or more embodiments, complex emulsifiers may produce invert emulsions having increased stability to temperature and pressure aging, particularly when assayed using electrical stability (ES), for example. The ES test, specified by the American Petroleum Institute at API Recommended Practice 13B-2, Third Edition (February 1998), is often used to determine the stability of the emulsion. ES is determined by applying a voltage-ramped, sinusoidal electrical signal across a probe (consisting of a pair of parallel flat-plate electrodes) immersed in the mud. The resulting current remains low until a threshold voltage is reached, whereupon the current rises very rapidly. This threshold voltage is referred to as the ES (“the API ES”) of the mud and is defined as the voltage in peak volts-measured when the current reaches 61 μA. The test is performed by inserting the ES probe into a cup of 120° F. (48.9° C.) mud applying an increasing voltage (from 0 to 2000 volts) across an electrode gap in the probe. The higher the ES voltage measured for the fluid, the stronger or harder to break would be the emulsion created with the fluid, and the more stable the emulsion is. Thus, the present disclosure relates to invert emulsion fluids having an electrical stability of at least 50 V in an embodiment, and in the range of 50 V to 2000 V in some embodiments, and from 75 V to 900 V in other embodiments.

When formulated as an invert emulsion, wellbore fluids may contain additional chemicals depending upon the end use of the fluid so long as they do not interfere with the functionality of the fluids (particularly the emulsion when using invert emulsion fluids) described herein. For example, weighting agents, wetting agents, organophilic clays, viscosifiers, fluid loss control agents, surfactants, dispersants, interfacial tension reducers, pH buffers, mutual solvents, thinners, thinning agents and cleaning agents may be added to the fluid compositions of this disclosure for additional functional properties.

In particular, the wellbore fluids of the present disclosure may be injected into a work string, flow to bottom of the wellbore, and then out of the work string and into the annulus between the work string and the casing or wellbore. This batch of treatment is typically referred to as a “pill.” The pill may be pushed by injection of other wellbore fluids such as completion fluids behind the pill to a position within the wellbore which is immediately above a portion of the formation where fluid loss is suspected. Injection of fluids into the wellbore is then stopped, and fluid loss will then move the pill toward the fluid loss location. Positioning the pill in a manner such as this is often referred to as “spotting” the pill. Injection of such pills is often through coiled tubing or by a process known as “bullheading.”

Upon introducing a wellbore fluid of the present disclosure into a borehole, a filtercake may be formed which provides an effective sealing layer on the walls of the borehole preventing undesired invasion of fluid into the formation through which the borehole is drilled. Filter cakes formed from wellbore fluids disclosed herein include multiple latex polymers and may have unexpected properties. Such properties may include increased pressure blockage, reliability of blockage, and increased range of formation pore size that can be blocked. These filtercakes may provide filtration control across temperature ranges up to greater than 400° F.

Where the formation is a low permeability formation such as shales or clays, the filtercakes formed using the wellbore fluids and methods of the present disclosure prevent wellbore fluid and filtrate loss by effectively blocking at least some of the pores of the low permeation formation. This may allow for support of the formation by maintaining sufficient pressure differential between the wellbore fluid column and the pores of the wellbore. Further, the filter cakes formed by wellbore fluids of the present disclosure may effectively seal earthen formations, and may be stable at elevated temperatures.

Although the preceding description has been described herein with reference to particular means, materials, and embodiments, it is not intended to be limited to the particulars disclosed herein; rather, it extends to all functionally equivalent structures, methods and uses, such as are within the scope of the appended claims.

What is claimed:

1. A wellbore fluid composition comprising:
an oleaginous base fluid comprising an aqueous internal phase forming a micelle;
a solid phase material;
a hydrophobic surface modifier capable of interacting with the solid phase material; and
a bifunctional surface modifier, wherein a first functional group of the bifunctional surface modifier interacts with the solid phase material, and a second functional group of the bifunctional surface modifier that interacts with the micelle of the aqueous internal phase.

2. The wellbore fluid composition of claim 1, wherein the second functional group is hydrophilic.

3. The wellbore fluid composition of claim 2, wherein the oleaginous base fluid forms an oleaginous external phase, and wherein the wellbore fluid has a ratio of the aqueous internal phase to the oleaginous external phase in a range of 30:70 to 95:5.

4. The wellbore fluid composition of claim 1, wherein the solid phase material is one or more clay particulates selected from the group consisting of montmorillonite, nontronite, beidellite, bentonite, volkonskoite, laponite, hectorite, saponite, sauconite, magadite, kenyaite, stevensite, vermiculite, halloysite, hydrotalcite, attapulgite, and sepiolite.

5. The wellbore fluid composition of claim 1, wherein the solid phase material has an average particle size or overall length in a range of 500 nm to 500 μm.

6. The wellbore fluid composition of claim 1, wherein the hydrophobic surface modifier has the general form of where R¹ is a functional group that interacts through covalent or non-covalent interactions with the solid phase material, and R¹ is a C8 to C30 alkyl or alkene.

7. The wellbore fluid composition of claim 1, wherein the hydrophobic surface modifier comprises an amine and a C8 to C18 alkyl chain.

8. The wellbore fluid composition of claim 1, wherein the second functional group of the bifunctional surface modifier comprises one or more of a carboxylic acid, a phosphoric acid, a sulfate, a sulfonate, an amine, an amide, or derivatives thereof.

9. The wellbore fluid composition of claim 1, wherein the molar ratio of hydrophobic surface modifier to bifunctional surface modifier is in the range of 5:1 to 75:1. mol/mol.

10. The wellbore fluid composition of claim 1, wherein the wellbore fluid composition has an electrical stability within a range of 50 V to 2000 V.

11. A method comprising:
emplacing a wellbore fluid into a wellbore, wherein the wellbore fluid comprises:
an oleaginous base fluid comprising an aqueous internal phase;
a solid phase material;
a hydrophobic surface modifier that interacts with the solid phase material; and
a bifunctional surface modifier, wherein a first functional group of the bifunctional surface modifier interacts with the solid phase material, and a second functional group that interacts with a micelle of the aqueous internal phase.

12. The method of claim 11, wherein the wellbore fluid further comprises an aqueous internal phase.

13. The method of claim 12, wherein the oleaginous base fluid forms an oleaginous external phase, and wherein the wellbore fluid has a ratio of the aqueous internal phase to the oleaginous external phase in a range of 30:70 to 95:5.

14. The method of claim 11, wherein the second functional group of the bifunctional surface modifier comprises one or more of a carboxylic acid, a phosphoric acid, a sulfate, a sulfonate, or derivatives thereof.

15. The method of claim 11, wherein the solid phase material is present in the wellbore fluid at a concentration that ranges from 0.5 to 3.0 wt %.

16. The method of claim 11, wherein the solid phase material is one or more clay particulates selected from the group consisting of montmorillonite, nontronite, beidellite, bentonite, volkonskoite, laponite, hectorite, saponite, sauconite, magadite, kenyaite, stevensite, vermiculite, halloysite, hydrotalcite, attapulgite, and sepiolite.

17. The method of claim 11, wherein the solid phase material is one or more particulates selected from the group consisting of silica, silicon materials, alumina particles, zirconia particles, and titania particles.

18. The method of claim 11, wherein a molar ratio of hydrophobic surface modifier to bifunctional surface modifier is in a range of 5:1 to 75:1 mol/mol.

19. The method of claim 11, wherein the wellbore fluid composition has an electrical stability within a range of 50 V to 2000 V.

20. The method of claim 11, wherein the second functional group is hydrophilic.
